(19) United States
(12) Patent Application Publication
(10) Pub. No.: US 2017/0124601 A1
(43) Pub. Date: May 4, 2017

(54) TECHNOLOGIES FOR DISTRIBUTING DIGITAL MEDIA CONTENT LICENSES

(71) Applicant: November Five LLC, Milford, OH (US)

(72) Inventor: William A. Donabedian, Milford, OH (US)

(21) Appl. No.: 15/277,317

(22) Filed: Sep. 27, 2016

Related U.S. Application Data
(60) Provisional application No. 62/249,450, filed on Nov. 2, 2015.

(51) Int. Cl. G06Q 30/02; G06Q 50/00; G06F 21/10

(52) U.S. Cl. CPC G06Q 30/0277; G06F 21/105; G06Q 30/0269; G06Q 50/01

(57) ABSTRACT

Technologies for managing distribution of licensed digital media content include a media license management server. The media license management server receives a media search request message including search parameters. A candidate list of digital media content items determined to match the search parameters is generated. The media license management server receives a license request corresponding to a selected digital media content item from the list. A licensed version of the selected digital media content item is transmitted to a computing device in response to acceptance of requested licensing terms. The licensed version of the digital media content item is presented during an advertisement. The advertisement includes a Uniform Resource Locator associated with a website from which playback of the digital media content item is available. In response to receiving a playback request, the licensed version of the digital media content item is streamed to a content player of the website.

### CROSS REFERENCE TO RELATED APPLICATION

This application claims the benefit of U.S. Provisional Patent Application Ser. No. 62/249,450, filed on Nov. 2, 2015, entitled TECHNOLOGIES FOR DISTRIBUTING DIGITAL MEDIA CONTENT LICENSES, the disclosure of which is hereby incorporated by reference in its entirety.

### TECHNICAL FIELD

Embodiments of the technologies described herein relate, in general, to the field of digital media content licensing. More particularly, the technologies described herein relate to the field of managing digital media content licensing between content producers and organizational entities.

### SUMMARY

In an embodiment, the present disclosure is directed, in part, to a method for managing distribution of licensed digital media content. The method includes receiving, by a media license management server, a media search request message. The media search request message includes search parameters that define a requested digital music track. The method also includes generating, by the media license management server, a candidate list of a plurality of digital music tracks determined to match the search parameters based at least in part on a plurality of electronic artist profiles of a plurality of artists. Additionally, the method includes receiving, by the media license management server, a license request message corresponding to a selected digital music track from the candidate list of the plurality of digital music tracks. The license request message can include requested licensing terms for the selected digital music track. The method further includes transmitting, by the media license management server, a licensed version of the selected digital music track to a remote computing device in response to a determination that the requested licensing terms for the selected digital music track are accepted. At least a portion of the licensed version of the selected digital music track is for presentation during an advertisement. The advertisement includes a Uniform Resource Locator (URL) corresponding to a website from which playback of the licensed version of the selected digital music track is available. Also, the method includes receiving, by the media license management server and from a music player of the website, a request for playback of the licensed version of the selected digital music track. Additionally, the method includes streaming, by the media license management server, the licensed version of the selected digital music track to the music player of the website in response to the request.

In some embodiments of the method, each of the plurality of electronic artist profiles is associated with a different artist of the plurality of artists and includes profile data and content-specific information. The profile data of each electronic artist profile describes characteristics of the artist and the content-specific information describes at least one digital music track associated with the artist. The method may also include determining, by the media license management server, whether the search parameters match one or more of the plurality artist profiles. In some embodiments, determining whether the search parameters match one or more of the plurality artist profiles includes determining a relevance score for each of the plurality of artist profiles indicating how closely each artist profile matches the search parameters.

Additionally, the method may further include automatically determining, by the media license management server, whether to one of accept, reject, or counter the requested licensing terms of the license request message for the selected digital music track based at least in part on reference acceptance criteria of the artist. In some embodiments, generating the candidate list of the plurality of digital music tracks includes generating a prioritized candidate list of the plurality of digital music tracks based on social media data. The profile data of each electronic artist profile may include at least one of a name of the artist, contact information associated with the artist, a hometown of the artist, biographic information corresponding to the artist, a photograph of the artist, a genre associated with the artist, and a performance calendar of the artist. Additionally or alternatively, the content-specific information of each electronic artist profile includes at least one of a title for each digital music track associated with the artist, searchable lyrics corresponding to each digital music track associated with the artist, a genre corresponding to each digital music track associated with the artist, a mood corresponding to each digital music track associated with the artist, a musical key of each digital music track associated with the artist, a description of each digital music track associated with the artist, a number of beats per minute for each digital music track associated with the artist, and a vocalist type of each digital music track associated with the artist. In some embodiments of the method, one or more of the plurality of electronic artist profiles include supplemental profile data. The supplemental profile data may include at least one of search engine relevance data associated with the artist, social media data associated with the artist, online electronic content associated with the artist, online review data associated with the artist, venue feedback data associated with the artist, and musical performance booking data associated with the artist. In some embodiments of the method, the advertisement includes at least one of an online electronic advertisement and a broadcast television advertisement.

In some embodiments, the method further includes generating, by the media license management server, tracking data corresponding to the request for playback of the licensed version of the selected digital music track. In such embodiments, the method also includes determining, by the media license management server, a royalty corresponding to the licensed version of the selected digital music track based at least in part on the tracking data. The method may also include receiving, by the media license management server, a request to purchase the licensed version of the selected digital music track.

In another embodiment, the present disclosure is directed, in part, to a media license management server for managing distribution of licensed digital media content. The media license management server includes logic stored in memory, which when executed by a processor of the media license management server, causes the media license management server to receive a media search request message. The media search request message may include search parameters that define a requested digital music track. Additionally, the logic further causes the media license management server to generate a candidate list of a plurality of digital music tracks determined to match the search parameters based at least in part on a plurality of electronic artist profiles of a plurality of artists. The logic also causes the media license management server to receive a license request message that corresponds to a selected digital music track from the candidate list of the plurality of digital music tracks. The license request message may include requested licensing terms for the selected digital music track. The logic also causes the media license management server to transmit a licensed version of the selected digital music track to a remote computing device in response to a determination that the requested licensing terms for the selected digital music track are accepted. At least a portion of the licensed version of the selected digital music track is for presentation during an advertisement. The advertisement includes a Uniform Resource Locator (URL) that corresponds to a website from which playback of the licensed version of the selected digital music track is available. The logic additionally causes the media license management server to receive, from a music player of the website, a request for playback of the licensed version of the selected digital music track and stream the licensed version of the selected digital music track to the music player of the website in response to the request.

In some embodiments of the media license management server, each of the plurality of electronic artist profiles is associated with a different artist of the plurality of artists and includes profile data and content-specific information. In such embodiments, the profile data of each electronic artist profile describes characteristics of the artist and the content-specific information describes at least one digital music track associated with the artist. The logic may further cause the media license management server to determine whether the search parameters match one or more of the plurality artist profiles. In some embodiments, the logic that causes the media license management server to determine whether the search parameters match one or more of the plurality artist profiles includes logic to cause the media license management server to determine a relevance score for each of the plurality of artist profiles that indicates how closely each artist profile matches the search parameters.

Additionally, in some embodiments, the logic further causes the media license management server to automatically determine whether to one of accept, reject, or counter the requested licensing terms of the license request message for the selected digital music track based at least in part on reference acceptance criteria of the artist. In some embodiment, the logic that causes the media license management server to generate the candidate list of the plurality of digital music tracks includes logic to cause the media license management server to generate a prioritized candidate list of the plurality of digital music tracks based on social media data.

The logic may also cause the media license management server to generate tracking data that corresponds to the request for playback of the licensed version of the selected digital music track and determine a royalty that corresponds to the licensed version of the selected digital music track based at least in part on the tracking data. In some embodiments, the logic may also cause the media license management server to receive a request to purchase the licensed version of the selected digital music track.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a simplified block diagram of at least one embodiment of a system for managing distribution of digital media content licenses;

FIG. 2 is a simplified sequence flow diagram in accordance with at least one non-limiting embodiment;

FIG. 3 is an exemplary advertisement including a digital media content item licensed via the media license management server of FIG. 1; and

FIG. 4 is an exemplary website of an organization for distributing the digital media content item licensed via the media license management server of FIG. 1.

### DETAILED DESCRIPTION

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

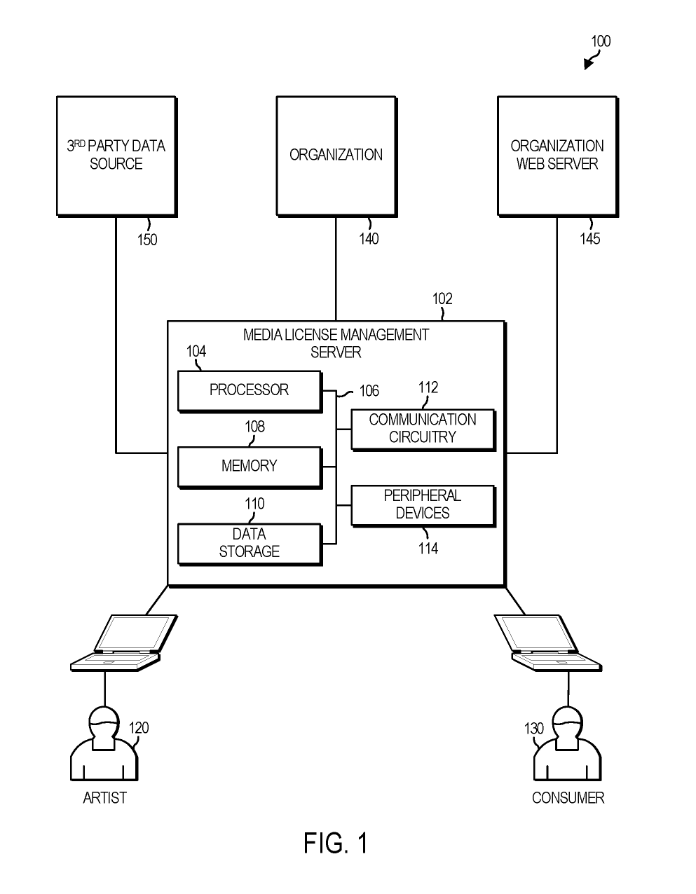

Referring now to FIG. 1, in one embodiment, a system 100 for managing distribution of digital media content licenses includes a media license management server 102, one or more artists 120, one or more consumers 130, one or more organizations 140, and one or more organization web servers 145. In some embodiments, the system 100 also includes one or more third party data sources 150. In operation, the media license management server 102 creates an electronic artist profile based on profile data received from the artist 120 or band. In some embodiments, the media license management server 102 can receive or collect additional profile data from the third-party data source(s) 150. In such embodiments, the media license management server 102 associates the additional profile data with the profile of the artist 120. After creation of the electronic artist profile, the artist 120 uploads a digital music track (or other form of digital media content) to the media license management server 102. In addition, the title and a searchable version of lyrics corresponding to the digital music track can also be uploaded to the media license management server 102 by the artist 120. In response to receiving the digital music track, title, and searchable version of the lyrics, the media license management server 102 associates the digital music track, title, lyrics, and/or any other type of information received from the artist 120 with the artist's electronic profile.

Additionally, the media license management server 102 receives a media search request from an organization 140 (or an entity associated therewith). Based on search criteria received in the media search request, the media license management server 102 generates a candidate list of music tracks. To do so, the media license management server 102 compares the search criteria to the electronic artist profiles managed by the media license management server 102. Subsequently, the organization 140 can select one of the music tracks included in the list and request a license from the artist 120 of the selected music track. The media license management server 102 can facilitate license negotiations between the organization 140 and the artist 120 of the selected music track. Upon acceptance of the licensing terms by the artist 120, the now licensed digital music track is transmitted to the organization 140 for use in an advertisement (e.g., a television advertisement, a radio advertisement, an electronic advertisement, etc.). Such advertisement can include information that identifies the title of the licensed music track, the artist of the licensed music track, and a Uniform Resource Locator (URL) corresponding to a website from which a consumer 130 can stream or replay the licensed music track.

In some embodiments, the organization web server 145 of the organization 140 hosts the website corresponding to the URL identified in the advertisement. The website can include a music player, which is configured to enable the consumer 130 to request streaming or playback of the licensed music track. In such embodiments, the media license management server 102 can receive a playback or streaming request for the licensed music track from the consumer 130 via the consumer's 130 interactions with the website and/or the music player provided therein. In response to receiving the request, the media license management server 102 can transmit or stream the requested licensed music track to a computing device associated with the consumer 130. In some embodiments, the media license management server 102 tracks playback or streaming requests for determining among other things, royalties, artist 120 popularity, consumer 130 interest in the artist 120, and marketing strategies.

The media license management server 102 can be embodied as any type of computing device or server or capable of processing, communicating, storing, maintaining, and transferring data. For example, the media license management server 102 can be embodied as a server, a microcomputer, a minicomputer, a mainframe, a desktop computer, a laptop computer, a mobile computing device, a handheld computer, a smart phone, a tablet computer, a personal digital assistant, a telephony device, a custom chip, an embedded processing device, or other computing device and/or suitable programmable device. In some embodiments, the media license management server 102 can be embodied as a computing device integrated with other systems or subsystems. In the illustrative embodiment of FIG. 1, the media license management server 102 includes a processor 104, a system bus 106, a memory 108, a data storage 110, communication circuitry 112, and one or more peripheral devices 114. Of course, the media license management server 102 can include other or additional components, such as those commonly found in a server and/or computer (e.g., various input/output devices), in other embodiments. Additionally, in some embodiments, one or more of the illustrative components can be incorporated in, or otherwise from a portion of, another component. For example, the memory 108, or portions thereof, can be incorporated in the processor 104 in some embodiments. Furthermore, it should be appreciated that the media license management server 102 can include other components, sub-components, and devices commonly found in a computer and/or computing device, which are not illustrated in FIG. 1 for clarity of the description.

The processor 104 can be embodied as any type of processor capable of performing the functions described herein. For example, the processor 104 can be embodied as a single or multi-core processor, a digital signal processor, microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or any other type of processor or processing/controlling circuit or controller.

In various configurations, the media license management server 102 includes a system bus 106 for interconnecting the various components of the media license management server 102. The system bus 106 can be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations with the processor 104, the memory 108, and other components of the media license management server 102. In some embodiments, the media license management server 102 can be integrated into one or more chips such as a programmable logic device or an application specific integrated circuit (ASIC). In such embodiments, the system bus 106 can form a portion of a system-on-a-chip (SoC) and be incorporated, along with the processor 104, the memory 108, and other components of the media license management server 102, on a single integrated circuit chip.

The memory 108 can be embodied as any type of volatile or non-volatile memory or data storage capable of performing the functions described herein. For example, the memory 108 can be embodied as read only memory (ROM), random access memory (RAM), cache memory associated with the processor 104, or other memories such as dynamic RAM (DRAM), static RAM (SRAM), programmable ROM (PROM), electrically erasable PROM (EEPROM), flash memory, a removable memory card or disk, a solid state drive, and so forth. In operation, the memory 108 can store various data and software used during operation of the media license management server 102 such as operating systems, applications, programs, libraries, and drivers.

The data storage 110 can be embodied as any type of device or devices configured for short-term or long-term storage of data such as, for example, memory devices and circuits, memory cards, hard disk drives, solid-state drives, or other data storage devices. For example, in some embodiments, the data storage 110 includes storage media such as a storage device that can be configured to have multiple modules, such as magnetic disk drives, floppy drives, tape drives, hard drives, optical drives and media, magneto-optical drives and media, Compact Disc (CD) drives, Compact Disc Read Only Memory (CD-ROM), Compact Disc Recordable (CD-R), Compact Disc Rewriteable (CD-RW), a suitable type of Digital Versatile Disc (DVD) or Blu-Ray disc, and so forth. Storage media such as flash drives, solid state hard drives, redundant array of individual disks (RAID), virtual drives, networked drives and other memory means including storage media on the processor 104, or the memory 108 are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

The communication circuitry 112 of the media license management server 102 may be embodied as any type of communication circuit, device, interface, or collection thereof, capable of enabling communications between the media license management server 102 and the artist 120 (or computing devices thereof), the consumer 130 (or computing devices thereof), the organization 140 (or computing devices thereof), the organization web server 145, the third party data source 150 (or computing devices thereof), and/or any other computing device communicatively coupled thereto. For example, the communication circuitry 112 may be embodied as one or more network interface controllers (NICs), in some embodiments. The communication circuitry 112 may be configured to use any one or more communication technologies (e.g., wireless or wired communications) and associated protocols (e.g., Ethernet, WiMAX, etc.) to effect such communication.

In some embodiments, the media license management server 102, the artist 120 (or computing devices thereof), the consumer 130 (or computing devices thereof), the organization 140 (or computing devices thereof), the organization web server 145, the third party data source 150 (or computing devices thereof), and/or any other computing devices of the system 100, can communicate with each other over one or more networks. The network(s) can be embodied as any number of various wired and/or wireless communication networks. For example, the network(s) can be embodied as or otherwise include a local area network (LAN), a wide area network (WAN), a cellular network, or a publicly-accessible, global network such as the Internet. Additionally, the network(s) can include any number of additional devices to facilitate communication between the computing devices of the system 100.

Additionally, in some embodiments, the media license management server 102 can further include one or more peripheral devices 114. Such peripheral devices 114 can include any type of peripheral device commonly found in a computing device such as additional data storage, speakers, a hardware keyboard, a keypad, a gesture or graphical input device, a motion input device, a touchscreen interface, one or more displays, an audio unit, a voice recognition unit, a vibratory device, a computer mouse, a peripheral communication device, and any other suitable user interface, input/output device, and/or other peripheral device.

The artist 120 can be embodied as any type of entity capable of performing the functions herein. In some embodiments, the artist 120 is a band or a collection of artists. The artist 120 can produce and/or perform various forms of media content (e.g., music tracks, videos, albums, etc.). The media content produced and/or performed by the artist 120 can be embodied as electronic or digital media content, which can be licensed and transmitted to one or more other entities (e.g., the organization 140, the consumer 130, etc.). In some embodiments, the artist 120 can perform at various venues, which can review and/or rank the artist's 120 performance. Such reviews and rankings can be managed or collected by one or more third party data sources 150. In the illustrative embodiment, the artist 120 licenses a music track to an organization 140 via the media license management server 102, as discussed in more detail below. In the illustrative embodiment, the artist 120 can utilize a computing device to upload digital media content items to the media license management server 102. Additionally, in some embodiments, the artist 120 can use a computing device to upload profile data and other content (e.g., lyrics, album art, etc.) to the media license management server 102.

The consumer 130 or customer can be embodied as any type of entity capable of performing the functions herein. In the illustrative embodiment, the consumer 130 can use a computing device to discover media content produced and/or performed by the artist 120. For example, in some embodiments, the consumer 130 can be exposed to a digital music track associated with an artist 120 via an advertisement (e.g., a television advertisement, an online advertisement, a radio advertisement, etc.) circulated by an organization 140 (or an advertising agency associated therewith). The advertisement can include a URL and information that identifies the artist 120 and the title of the digital music track. In such cases, the consumer 130 can utilize a computing device to access the URL and listen to the digital music track again. In some embodiments, the consumer 130 can be provided with an option of purchasing the digital music track and/or adding the digital music track to a streaming playlist.

The organization 140 can be any type of organization or entity that manufactures or provides goods or services to consumers (e.g., the consumer 130). Additionally or alternatively, the organization 140 can be an advertising agency or another entity that promotes the goods and services manufactured or provided by an organization. In the illustrative embodiment, the organization 140 can be interested in licensing a music track (or other digital media content) from an artist 120. In such cases, the organization 140 (or an entity associated therewith) can use one or more computing devices to identify the digital music track that the organization 140 is interested in licensing for use in an advertisement. To do so, the organization 140 can use a computing device to request a list of candidate digital music tracks from the media license management server 102 that match search criteria (e.g., genre, keywords, artist location, popularity, etc.). The organization 140 can select one of the digital music tracks included in the list provided by the media license server 102 and request a license from the corresponding artist 120 to use the selected digital music track in an advertisement. As discussed in more detail below, the media license management server 102 can facilitate license negotiations between the artist 120 of the selected digital music track and the organization 140. If the artist 120 accepts the terms of the license, the organization 140 (or a computing device associated therewith) can receive the licensed digital music track from the media license management server 102. Thereafter, the organization 140 can use the licensed digital music track in an advertisement for a product or service. The advertisement can include information that identifies the artist 120 of the digital music track, the title of the digital music track, and a Uniform Resource Locator (“URL”) corresponding to a website at which the consumer 130 can access to stream or otherwise replay the licensed digital music track.

In some embodiments, the organization 140 is associated with an organization web server 145. The organization web server 145 can be embodied as any type of computing device capable of performing the functions described herein. As such, the organization web server 145 can include devices and structures commonly found in computing devices such as processors, memory devices, communication circuitry, and data storages, which are not shown in FIG. 1 for clarity of the description. As discussed above, advertisements of the organization 140 can include URLs that correspond to websites at which the consumer 130 can access to stream or replay licensed digital music tracks features in one or more advertisements. In such cases, the organization web server 145 can host those websites. In some embodiments, the websites hosted by the organization web server 145 can include product or service advertisements along with a music player (e.g. a cloud player, a stand-alone player, etc.). The music player can be configured to communicate with the media license management server 102 to replay the licensed digital music track. Additionally, in some embodiments, the music player and/or the websites hosted by the organization web server 145 can provide an interface to the consumer 130 for purchasing a personal copy of the licensed digital music track. Additionally or alternatively, the music player and/or the websites hosted by the organization web server 145 may provide an interface to the consumer 130 for adding the licensed digital music track to a streaming playlist for playback at a later time.

In some embodiments, the media license management server 102, the artist(s) 120 (or computing devices thereof), the consumer(s) 130 (or computing devices thereof), the organization(s) 140 (or computing devices thereof), the organization web server(s) 145, and the third party data source(s) 150 (or computing devices thereof) can each establish an environment during operation. Each environment can include various modules, components, sub-components, and devices commonly found in computing devices, which are not illustrated in the figures for clarity of the description. The various modules, components, sub-components, and devices of each environment can be embodied as hardware, firmware, software, or a combination thereof. For example, one or more of the modules, components, sub-components, and devices of each environment can be embodied as a processor and/or a controller configured to provide the functionality described herein.

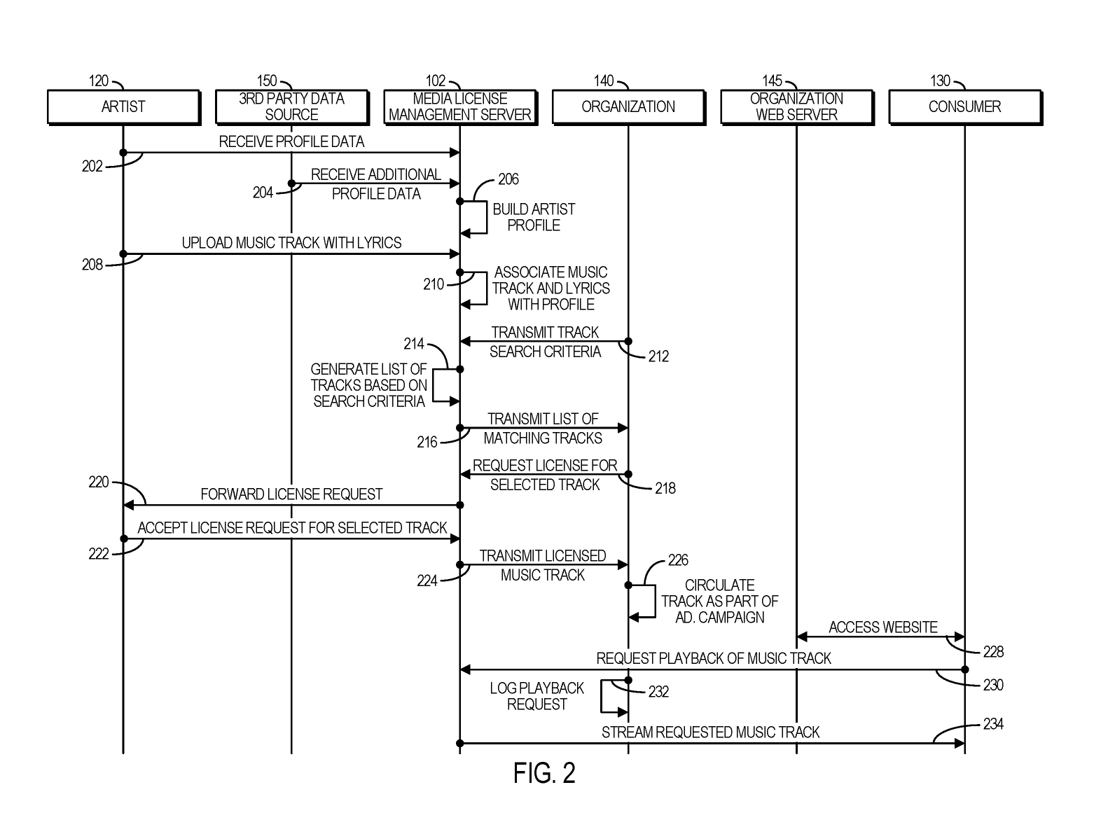

Referring now to FIG. 2, a process that may be executed by the devices of the system 100 begins with process flow 202. In process flow 202, the media license management server 102 can receive profile data from the artist 120 or band (or a computing device associated therewith) that describes characteristics of, or information related to, the artist 120 or band. For example, in some embodiments, the media license management server 102 can receive profile data such as the name of the artist 120 or band, contact information associated with the artist 120 or band, the year in which the artist 120 started performing or the band was formed, the number of members in the band, the hometown (e.g., city and state) of the artist 120 or the band, a short or long bio corresponding to the artist 120 or band, a photo of the artist 120 or the band, genre data (e.g., rock, pop, country, etc.) associated with the artist 120 or the band, and/or a performance calendar of the artist 120 or the band. It should be appreciated that any other type of profile data can be received by the media license management server 102 from the artist 120 or the band.

In process flow 204, the media license management server 102 can receive additional or supplemental profile data corresponding to the artist 120 or the band from one or more third party data sources 150 (or a computing device associated therewith). For example, in some embodiments, the media license management server 102 can receive or collect additional profile data such as search engine relevance data associated with the artist 120 or the band, social media data associated with the artist 120 or the band (e.g., likes, dislikes, trends, followers, friends, fans, subscribers, connections, metadata tags, posts, reposts, etc.), online electronic content data associated with the artist 120 or the band (e.g., online video views, online music listens, downloads, etc.), online review data associated with the artist 120 or the band (e.g., judge or critic reviews, etc.), venue or festival feedback data associated with the artist 120 or the band (e.g., show advancement data, show promotion data, timeliness data, setup and sound check feedback, crowd draw data, crowd retention data, level of professionalism data, etc.), musical performance booking data associated with the artist 120 or the band (e.g., ticket sales data, number of performances booked, etc.), and/or any other type of supplemental profile data that describes or is associated with the artist 120 or the band.

In process flow 206, the media license management server 102 builds an electronic profile for the artist 120 or the band based at least in part on, or otherwise as a function of, the profile data received from the artist 120 or band and, if any, the additional profile data received from the third party data source(s) 150. In process flow 208, after the profile has been created, the artist 120 can upload or transmit a digital media content item to the media license server 102. For example, in the illustrative embodiment, the artist 120 uploads a digital music track (e.g., a song) to the media license management server 102. In addition, the title and a searchable version of lyrics corresponding to the digital music track can also be uploaded to the media license management server 102. Other types of content-specific information corresponding to the digital music track can also be transmitted to the media license management server 102, in some embodiments. For example, the genre of the digital music track, the mood of the digital music track, an explicit content indicator, the beats per minute of the digital music track, the vocalist type (e.g., male vocalist, female vocalist, both male and female vocalists, a choir, children, etc.) of the digital music track, the musical key of the digital music track, relevant instruments/sounds of the digital music track, a list of other artists or songs similar to the artist 120 or the digital music track, and/or a description (e.g., a short description, a long description, etc.) of the digital music track. It should be appreciated, however, that the artist 120 can also upload other types of digital media content items (e.g., videos, album cover art, etc.) to the media license management server 102. Subsequently, in process flow 210, the media license management server 102 associates the digital music track, title, lyrics, and/or any other type of information received from the artist 120 with the artist's electronic profile.

At a later point in time, in process flow 212, an organization 140 can transmit a media search request to the media license management server 102. The organization 140 can be any type of organization or entity interested in licensing digital media content (e.g., a music track) from the artist 120. For example, in some embodiments, the organization 140 can be a manufacturer of one or more product or service brands. The media search request transmitted by the organization 140 can include search parameters or search criteria (e.g., genre, lyrics, hometown of artist or band, length, etc.) that define the parameters or the type of digital music track being sought.

In process flow 214, the media license management server 102 can generate a list of music tracks that match the search criteria received from the organization 140. It should be appreciated that, in some embodiments, the music tracks included in the generated list may associated with more than one artist 120 or band. That is, the generated list may contain music tracks provided by different artists 120 or bands, the same artist 120 or band, or a combination thereof In order to generate the list of music tracks, the media license management server 102 can search for electronic artist profiles having profile data that matches the received search criteria. In some embodiments, the list of matching music tracks can be generated based on a relevance score or threshold indicating how closely a music track and/or the electronic profile of a particular artist 120 matches the received search criteria.

Additionally, in some embodiments, the list of music tracks that match the search criteria can be ordered or prioritized based a variety of factors or sorting algorithms. For example, a music track corresponding to an artist 120 or a band may be prioritized in the list in response to data indicating that such artist 120 or band is currently being selected for one or more upcoming gigs or is experiencing an increase or decrease in ticket sales. In another example, a music track corresponding to an artist 120 or a band may be prioritized in the list in response to data indicating that such artist 120 or band is currently experiencing an increase or decrease in social media followers or subscribers. In yet another example, a music track corresponding to an artist 120 or a band may be prioritized in the list in response positive review data received from event organizers, festival owners, critics, fans, or any other interested party. It should be appreciated that any other type of data indicating that an artist 120 or band is gaining or losing momentum can be used to prioritize a music track of the artist 120 or band in the list. In process flow 216, the generated list of music tracks can be transmitted to the organization 140 for review. In some embodiments, the media license management server 102 can be configured to enable the organization 140 (or an employee thereof) to preview (via a computing device) a digital version of each music track included in the provided list.

In process flow 218, if the organization 140 likes one of the music tracks included in the provided list, the organization 140 sends a license request (e.g., a license request message) for the music track to the media license management server 102. The license request message can include licensing terms (e.g., usage in an advertising campaign for a particular product, usage location radius, length of use, etc.) requested by the organization 140. Subsequently, in process flow 220, the media license server 102 can forward the license request message for the music track to the associated artist 120 or band. In process flow 222, if the artist 120 or band of the music track agrees to the terms of the license requested by the organization 140, the artist 120 or band (or a computing device thereof) can transmit a license acceptance message to the media license management server 102. In other cases, the artist 120 or band (or a computing device thereof) can transmit a counteroffer to the media license management server 102, which can then forward the counteroffer to the organization 140 for review. In some embodiments, the media license management server 102 can be configured to facilitate license negotiations between the artist 120 and the organization 140. For example, the media license management server 102 can be configured to automatically accept a license request, automatically deny a license request, automatically counter a license request, or flag a license request in response to determining that the terms of the license request are above a reference license term threshold, below a reference license term threshold, or do not meet configurable or reference acceptance criteria of the artist 120 or band.

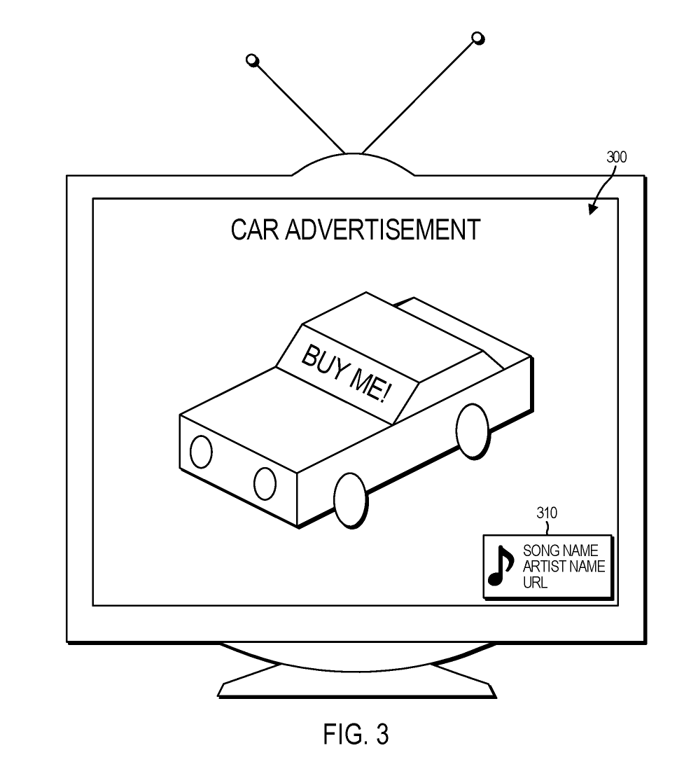

In process flow 224, after receiving acceptance of the license request from the artist 120 (or a computing device thereof), the media license management server 102 transmits the licensed digital music track to the organization 140. In some embodiments, upon acceptance of the license request by the artist 120, or upon transmission of the licensed digital music track to the organization 140, the organization 140 can pay an administration fee to the media license management server 102 (or a controlling entity). In process flow 226, upon receiving the licensed digital music track, the organization 140 can circulate (e.g., play, replay, playback, broadcast, employ, incorporate, present, etc.) the licensed digital music track in online (e.g., electronic) and broadcast television advertisements as part of an advertising campaign. For example, in some embodiments, the organization 140 can include the licensed digital music track as background music in a television commercial, in a radio commercial, or in an online advertising window, frame, overlay, and/or banner. In such embodiments, the online or broadcast advertisement including the licensed digital music track can also include music track identification data that describes and/or identifies the licensed digital music track and the artist 120 thereof. Additionally, in some embodiments, the music track identification data identifies an electronic location (e.g., a website URL) at which a consumer 130 or viewer can go to stream, playback, or otherwise obtain the licensed digital music track or a portion thereof. For example, in embodiments in which the licensed digital music track is included in a television commercial (e.g., the television commercial 300 illustratively shown in FIG. 3), the television commercial can include a watermark, bug, or other type of on-screen data (e.g., the music track identification data 310) that identifies the name of the licensed music track, the name of the artist 120, and a URL of a website at which the consumer 130 can access to stream or obtain the licensed music track.

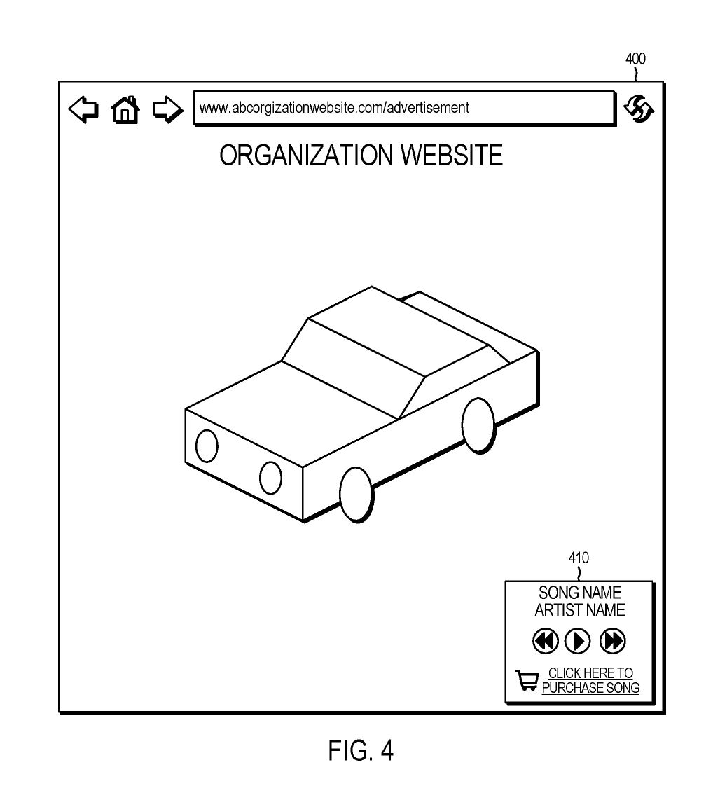

In process flow 228, the consumer 130 or viewer can access the URL of the website (e.g., the website 400 illustratively shown in FIG. 4) identified in the music track identification data (e.g., the identification data 310 of FIG. 3) included with the broadcast or electronic advertisement. In embodiments such as the one illustratively shown in FIG. 4, the website 400 can include a music player 410. In such embodiments, the music player 410 can be embodied as a widget, a pop-up window, or other electronic element displayed or otherwise accessible via the website 400. In some embodiments, the music player 410 can be embodied as a stand-alone mobile application or software product associated with or provided by the organization 140. Additionally or alternatively, the music player 410 can form part of or can be incorporated within a mobile application or software product associated with or provided by the organization 140. The music player 410 can execute on the computing device of the consumer 130 and can be configured to stream or otherwise replay the licensed music track. To do so, in process flow 230, the music player 410 can request playback of the licensed music track from the media license management server 102. In some embodiments, the media license management server 102 can, in process flow 232, log or track the request for playback of the licensed music track. To do so, in some embodiments, the media license management server 102 can generate corresponding log data or tracking data. Such log data or tracking data can be used to determine among other things, royalties (e.g., artist royalties, music track royalties, etc.), artist 120 popularity, consumer 130 interest in the artist 120, and marketing strategies. Additionally, in some embodiments such as the one shown in FIG. 4, the music player 410 can be configured to enable a consumer to purchase a personal licensed version of the licensed music track. In process flow 234, the media license management server 102 can stream the requested license music track to the music player 410 executing on the computing device of the consumer 130.

Additionally, in some embodiments, the music player 410 can include a rating feature (e.g., a star-rating feature, a numerical-rating feature, etc.) or a “like/dislike” feature configured to enable the consumer 130 to rate and/or rank a licensed music track. Such ratings or “likes/dislikes” can be analyzed by the media license management server 102 for determining royalties, artist 120 popularity, consumer 130 interest in the artist 120, and marketing strategies. Additionally or alternatively, in some embodiments, the music player 410 can include a link or URL to the website or social media presence of the artist 120 or band of the licensed music track.

In some embodiments, the media license management server 102 can create a consumer profile associated with the consumer 130. In such embodiments, the media license management server 102 can track music or media preferences, behaviors, and/or purchases of the consumer 130. Based on the consumer profile, the media license management server 102 can, over time, suggest new music tracks and artists 120 to the consumer 130. Additionally, the media license management server 102 can use the consumer profile to notify the consumer 130 when their favorite artists 120 or bands are in town. In such cases, the media license management server 102 can be configured to sell tickets to the upcoming local performances by the artists 120 or bands.

Additionally, information collected in the consumer profile can be shared with artists 120 or bands. Such information can be used by the artists 120 or bands to identify where their fans are located (e.g., top countries, top cities, etc.), which can be helpful in planning touring schedules. The shared consumer profile information can also be used by the artists 120 or bands to determine the demographics of their listeners (e.g., percentage of male listeners versus female listeners, percentage of listeners in or over an age range, languages spoken, etc.).

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

1. A method for managing distribution of licensed digital media content, the method comprising:
receiving, by a media license management server, a media search request message, the media search request message comprises search parameters that define a requested digital music track;
generating, by the media license management server, a candidate list of a plurality of digital music tracks determined to match the search parameters based at least in part on a plurality of electronic artist profiles of a plurality of artists;
receiving, by the media license management server, a license request message corresponding to a selected digital music track from the candidate list of the plurality of digital music tracks, the license request message comprises requested licensing terms for the selected digital music track;
transmitting, by the media license management server, a licensed version of the selected digital music track to a remote computing device in response to a determination that the requested licensing terms for the selected digital music track are accepted, wherein at least a portion of the licensed version of the selected digital music track is for presentation during an advertisement, the advertisement comprises a Uniform Resource Locator (URL) corresponding to a website from which playback of the licensed version of the selected digital music track is available;
receiving, by the media license management server and from a music player of the website, a request for playback of the licensed version of the selected digital music track; and
streaming, by the media license management server, the licensed version of the selected digital music track to the music player of the website in response to the request.

2. The method of claim 1, wherein each of the plurality of electronic artist profiles is associated with a different artist of the plurality of artists and comprises profile data and content-specific information, the profile data of each electronic artist profile describes characteristics of the artist and the content-specific information describes at least one digital music track associated with the artist.

3. The method of claim 2, further comprising determining, by the media license management server, whether the search parameters match one or more of the plurality artist profiles.

4. The method of claim 3, wherein determining whether the search parameters match one or more of the plurality artist profiles comprises determining a relevance score for each of the plurality of artist profiles indicating how closely each artist profile matches the search parameters.

5. The method of claim 2, further comprising automatically determining, by the media license management server, whether to one of accept, reject, or counter the requested licensing terms of the license request message for the selected digital music track based at least in part on reference acceptance criteria of the artist.

6. The method of claim 2, wherein generating the candidate list of the plurality of digital music tracks comprises generating a prioritized candidate list of the plurality of digital music tracks based on social media data.

7. The method of claim 2, wherein the profile data of each electronic artist profile comprises at least one of a name of the artist, contact information associated with the artist, a hometown of the artist, biographic information corresponding to the artist, a photograph of the artist, a genre associated with the artist, and a performance calendar of the artist.

8. The method of claim 2, wherein the content-specific information of each electronic artist profile comprises at least one of a title for each digital music track associated with the artist, searchable lyrics corresponding to each digital music track associated with the artist, a genre corresponding to each digital music track associated with the artist, a mood corresponding to each digital music track associated with the artist, a musical key of each digital music track associated with the artist, a description of each digital music track associated with the artist, a number of beats per minute for each digital music track associated with the artist, and a vocalist type of each digital music track associated with the artist.

9. The method of claim 2, wherein one or more of the plurality of electronic artist profiles comprise supplemental profile data, the supplemental profile data comprises at least one of search engine relevance data associated with the artist, social media data associated with the artist, online electronic content associated with the artist, online review data associated with the artist, venue feedback data associated with the artist, and musical performance booking data associated with the artist.

10. The method of claim 1, wherein the advertisement comprises at least one of an online electronic advertisement and a broadcast television advertisement.

11. The method of claim 1, further comprising:
generating, by the media license management server, tracking data corresponding to the request for playback of the licensed version of the selected digital music track; and
determining, by the media license management server, a royalty corresponding to the licensed version of the selected digital music track based at least in part on the tracking data.

12. The method of claim 1, further comprising receiving, by the media license management server, a request to purchase the licensed version of the selected digital music track.

13. A media license management server for managing distribution of licensed digital media content comprising logic stored in memory, which when executed by a processor of the media license management server, causes the media license management server to:
receive a media search request message, the media search request message comprises search parameters that define a requested digital music track;
generate a candidate list of a plurality of digital music tracks determined to match the search parameters based at least in part on a plurality of electronic artist profiles of a plurality of artists;
receive a license request message that corresponds to a selected digital music track from the candidate list of the plurality of digital music tracks, the license request message comprises requested licensing terms for the selected digital music track;
transmit a licensed version of the selected digital music track to a remote computing device in response to a determination that the requested licensing terms for the selected digital music track are accepted, wherein at least a portion of the licensed version of the selected digital music track is for presentation during an advertisement, the advertisement comprises a Uniform Resource Locator (URL) that corresponds to a website from which playback of the licensed version of the selected digital music track is available;
receive, from a music player of the website, a request for playback of the licensed version of the selected digital music track; and
stream the licensed version of the selected digital music track to the music player of the website in response to the request.

14. The media license management server of claim 13, wherein each of the plurality of electronic artist profiles is associated with a different artist of the plurality of artists and comprises profile data and content-specific information, the profile data of each electronic artist profile describes characteristics of the artist and the content-specific information describes at least one digital music track associated with the artist.

15. The media license management server of claim 14, wherein the logic further causes the media license management server to determine whether the search parameters match one or more of the plurality artist profiles.

16. The media license management server of claim 15, wherein to determine whether the search parameters match one or more of the plurality artist profiles comprises to determine a relevance score for each of the plurality of artist profiles that indicates how closely each artist profile matches the search parameters.

17. The media license management server of claim 14, wherein the logic further causes the media license management server to automatically determine whether to one of accept, reject, or counter the requested licensing terms of the license request message for the selected digital music track based at least in part on reference acceptance criteria of the artist.

18. The media license management server of claim 14, wherein to generate the candidate list of the plurality of digital music tracks comprises to generate a prioritized candidate list of the plurality of digital music tracks based on social media data.

19. The media license management server of claim 13, wherein the logic further causes the media license management server to:
generate tracking data that corresponds to the request for playback of the licensed version of the selected digital music track; and
determine a royalty that corresponds to the licensed version of the selected digital music track based at least in part on the tracking data.

20. The media license management server of claim 13, wherein the logic further causes the media license management server to receive a request to purchase the licensed version of the selected digital music track.
